(19) United States
(12) Patent Application Publication
(10) Pub. No.: US 2025/0174385 A1
(43) Pub. Date: May 29, 2025

(54) Multilayer Structure Including an Inductor and Methods for Forming a Multilayer Structure

(71) Applicant: KYOCERA AVX Components Corporation, Fountain Inn, SC (US)

(72) Inventors: Cory Nelson, Simpsonville, SC (US); Marianne Berolini, Greer, SC (US); Jonathan Herr, Taylors, SC (US)

(21) Appl. No.: 18/945,625

(22) Filed: Nov. 13, 2024

Related U.S. Application Data
(60) Provisional application No. 63/602,685, filed on Nov. 27, 2023.

(51) Int. Cl. H01F 17/00

(52) U.S. Cl. CPC H01F 17/0013; H01F 2017/002; H01F 2017/0046

(57) ABSTRACT

Multilayer structures and methods for forming multilayer structures and assemblies are provided. For example, a multilayer structure includes a plurality of dielectric layers stacked along a Z-direction; a first surface; a second surface opposite the first surface along the Z-direction; a via extending from the first surface to the second surface; a first conductive path defined on the first surface; and a second conductive path defined on the second surface. The via contacts both the first conductive path and the second conductive path to electrically connect the first conductive path to the second conductive path. The first conductive path, the second conductive path, and the via form an inductor.

### RELATED APPLICATION

The present application is based upon and claims priority to U.S. provisional patent application Ser. No. 63/602,685, having a filing date of Nov. 27, 2023, which is incorporated herein by reference.

### BACKGROUND OF THE INVENTION

High frequency radio signal communication has increased in popularity. For example, the demand for increased data transmission speed for wireless connectivity has driven demand for high frequency components, including those configured to operate at high frequencies, including 5G spectrum frequencies. A trend towards miniaturization has also increased the desirability of small, passive components. Further, electronic devices often include inductors, e.g., filters often include one or more inductors that are designed to provide specific inductance values. However, increasing or maximizing inductance in smaller components can be difficult to achieve. As such, a low profile, high inductance component would be welcomed in the art.

### SUMMARY OF THE INVENTION

In accordance with one embodiment of the present invention, a multilayer structure is provided. The multilayer structure includes a plurality of dielectric layers stacked along a Z-direction; a first surface; a second surface opposite the first surface along the Z-direction; a via extending from the first surface to the second surface; a first conductive path defined on the first surface; and a second conductive path defined on the second surface. The via contacts both the first conductive path and the second conductive path to electrically connect the first conductive path to the second conductive path. The first conductive path, the second conductive path, and the via form an inductor.

In accordance with another embodiment of the present invention, a multilayer structure is provided. The multilayer structure includes a plurality of dielectric layers stacked along a Z-direction; a first surface; a second surface opposite the first surface along the Z-direction; a plurality of vias extending from the first surface to the second surface; a first conductive path defined on the first surface; and a second conductive path defined on the second surface. The first conductive path extends between a first portion of the plurality of vias, and the second conductive path extends between a second portion of the plurality of vias. At least one via of the plurality of vias is included in both the first portion of the plurality of vias and the second portion of the plurality of vias. The first conductive path, the second conductive path, the first portion of the plurality of vias, and second portion of the plurality of vias form an inductor.

In accordance with still another embodiment of the present invention, a method for forming a multilayer structure is provided. The method includes forming a plurality of dielectric layers; stacking the plurality of dielectric layers along a Z-direction; defining at least one via extending from a first surface to a second surface, the second surface opposite the first surface along the Z-direction; forming a first conductive path on the first surface; and forming a second conductive path on the second surface. The via contacts both the first conductive path and the second conductive path to electrically connect the first conductive path to the second conductive path. The first conductive path, the second conductive path, and the via form an inductor.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 illustrates a schematic top view of an assembly including an inductor of the present invention;

FIG. 2A illustrates a schematic cross-section view of the assembly of FIG. 1 according to one embodiment of the present invention;

FIG. 2B illustrates a schematic cross-section view of the assembly of FIG. 1 according to another embodiment of the present invention;

FIG. 3 illustrates a schematic top view of an assembly including another inductor of the present invention;

FIG. 4A illustrates a schematic cross-section view of an assembly including a multilayer structure according to one embodiment of the present invention;

FIG. 4B illustrates a schematic cross-section view of an assembly including a multilayer structure according to another embodiment of the present invention;

FIG. 5 illustrates a schematic cross-section view of an assembly including a multilayer structure according to still another embodiment of the present invention;

FIG. 6 provides a flow chart of a method for forming an inductor of the present invention; and

FIG. 7 provides a flow chart of a method for forming a multilayer structure of the present invention.

Repeat reference to characters in the present specification and figures is intended to represent same or analogous features or elements of the invention.

### DETAILED DESCRIPTION OF THE INVENTION

It is to be understood by one of ordinary skill in the art that the present discussion is a description of exemplary embodiments only and is not intended as limiting the broader aspects of the present invention.

Generally speaking, the present invention is directed to inductors, such as an inductor extending from a first end to a second end that are defined on separate surfaces of a structure, such as a core or a multilayer structure. For example, an inductor may include at least one via extending from a first surface to a second surface, a first conductive path formed over the first surface and connected to the via, a second conductive path formed over the second surface and connected to the via such that the first conductive path is electrically connected to the second conductive path through the via.

In some embodiments, the first conductive path is formed over a first surface of a core, and the second conductive path is formed over a second surface of the core. The second surface, for instance, is opposite the first surface along a Z-direction. The first conductive path and the second conductive path, electrically connected to one another through at least one via extending through the core, may form a coil wrapped inductor structure. As one example, an inductor can include a core having a first surface and a second surface opposite the first surface along a Z-direction, at least one via extending from the first surface to the second surface, a first conductive path defined on the first surface, and a second conductive path defined on the second surface, wherein the at least one via contacts both the first conductive path and the second conductive path to electrically connect the first conductive path to the second conductive path. The first conductive path and/or the second conductive path may have a shape, a pattern, or otherwise be defined to “wrap around” the core and form a coil wrapped inductor structure.

The first conductive path and the second conductive path, as well as the one or more vias, may be formed from thin films. The core and thin film structure that form the inductor can have a lower profile and higher inductance value than typical thin film inductors. Further, the core may be formed from a ferrite material or other such material, e.g., to increase the inductance value of the inductor formed as described herein.

In some embodiments, the core may be sandwiched between dielectric layers to form a multilayer structure. For example, in some embodiments, the first and second conductive paths may be formed on opposite surfaces of the core that is stacked with the dielectric layers along a Z-direction such that the core is sandwiched between dielectric layers. In other embodiments, at least one of the first conductive path or the second conductive path may be formed on a dielectric layer that is stacked with the core. For instance, the first conductive path may be defined on a first dielectric layer and the second conductive path may be formed on a second dielectric layer, with the first and second dielectric layers stacked with the core such that the first conductive path is formed on a first surface of the stack and the second conductive path is formed on a second surface of the stack that is opposite the first surface. The first and second surfaces of the stack may be, e.g., outer surfaces of the multilayer structure.

In other embodiments, a plurality of dielectric layers may be stacked along a Z-direction without the core to form a multilayer structure. For example, the first conductive path may be defined on a first dielectric layer of the multilayer structure and the second conductive path may be formed on a second dielectric layer of the multilayer structure, with the first and second dielectric layers stacked together (e.g., with one or more additional dielectric layers) such that the first conductive path is formed on a first surface of the stack and the second conductive path is formed on a second surface of the stack that is opposite the first surface. The first and second surfaces of the stack may be, e.g., outer surfaces of the multilayer structure.

Such a multilayer structure can be used to change the inductance of the inductor (e.g., as compared to the inductor formed with only the core) and/or to provide additional functionality. For instance, one or more dielectric layers, stacked with or without the core, can include conductive material that lengthens the inductor to change the inductance value, defines additional passive components, routes signals, etc. Like the core structure described above, the multilayer structure can provide higher inductance for the same profile or a lower profile than typical thin film inductors, as well as additional functionality if desired.

As described herein, in some embodiments, an inductor includes a core having a first surface and a second surface opposite the first surface along a Z-direction. The inductor further includes a plurality of vias extending from the first surface to the second surface. A first conductive path may be defined on the first surface, where the first conductive path extends between a first portion of the plurality of vias. A second conductive path may be defined on the second surface, where the second conductive path extending between a second portion of the plurality of vias. At least one via of the plurality of vias may be included in both the first portion of the plurality of vias and the second portion of the plurality of vias.

In some embodiments, the first surface and the second surface each extending in a respective plane that is parallel to an X-Y plane that is perpendicular to the Z-direction. For example, the inductor may define an X-direction that is perpendicular to a Y-direction, which are each perpendicular to the Z-direction. The X-direction and the Y-direction may define the X-Y plane. The first surface may extend in the X-direction and the Y-direction in a first plane parallel to the X-Y plane, and the second surface may extend in the X-direction and the Y-direction in a second plane parallel to the X-Y plane and the first plane.

In some embodiments, the plurality of vias are defined along a first side and a second side of the core, where the first side is opposite the second side along the Y-direction. The vias defined along the first side may be spaced apart from one another along the X-direction, and the vias defined along the second side may be spaced apart from one another along the X-direction.

In various embodiments, the vias may be adjacent to the respective first side or second side, or the vias may be exposed to the respective first side or second side, which may be referred to as a castellated design. For example, the core (or the multilayer structure having vias as described elsewhere herein) may be cut or diced along a line extending through vias aligned with one another along the X-direction to define the first side or the second side of the core (or multilayer structure) and to thereby expose the vias along the respective side. In some embodiments, a portion of the plurality of vias are exposed along the first side, and another portion of the plurality of vias are exposed along the second side.

In other embodiments, the core (or multilayer structure) may be cut or diced such that vias are not exposed along a respective side but, e.g., are merely adjacent the respective side. For instance, at least one via of a first portion of the plurality of vias is defined adjacent the first side and at least one via of the first portion of the plurality of vias is defined adjacent the second side. Similarly, at least one via of the second portion of the plurality of vias may be defined adjacent the first side and at least one via of the second portion of the plurality of may be defined adjacent the second side.

In some embodiments, at least one via is electrically connected to an input and to an output. For example, one via of the plurality of vias may be electrically connected to an input and another via of the plurality of vias may be electrically connected to an output. The input may include an input pad and the output may include an output pad. Both the input pad and the output pad may be formed from a conductive material, and both the input pad and the output pad may be defined on either the first surface or the second surface of the core or multilayer structure. The one or more vias may be electrically connected to the input and/or to the output through one or more connectors formed from a conductive material that extends from the respective via to the input or to the output.

In some embodiments, the first conductive path may include a plurality of legs, each leg of the plurality of legs extending on the first surface between a respective two vias of the plurality of vias. Similarly, the second conductive path may include a plurality of legs, each leg of the plurality of legs extending on the second surface between a respective two vias of the plurality of vias.

The input and the output can define a first end and a second end of the inductor, and the inductor may have an inductor length from the first end to the second end. In at least some embodiments, the inductor length includes a length in the Z-direction of each via of the plurality of vias that contacts at least one of the first conductive path or the second conductive path, a length of each leg of the plurality of legs of the first conductive path, and a length of each leg of the plurality of legs of the second conductive path. The length of each leg of the first conductive path may be measured along the first surface of the core or multilayer structure from one via to the other via between which extends the respective leg, and the length of each leg of the second conductive path may be measured along the second surface of the core or multilayer structure from one via to the other via between which extends the respective leg.

In some embodiments, the plurality of vias are defined along two or more edges of the core or multilayer structure to maximize the inductor length of the inductor. For example, the vias can be defined as close to the first side and the second side of the core or multilayer structure to maximize the length of each leg of the first and second conductive paths. Maximizing the inductor length can help maximize the inductance of the inductor. Other factors, such as the core material, can also help increase or maximize the inductance of the inductor.

In some embodiments, the plurality of vias includes a first via, a second via, and a third via. The first conductive path may extend from the first via to the second via, and the second conductive path may extend from the second via to the third via.

In other embodiments, the plurality of vias includes a first via, a second via, a third via, and a fourth via. For example, the first via and third via may be defined along the first side of the core or multilayer structure, and the second via and fourth via may be defined along the second side of the core or multilayer structure. The first conductive path may include a first leg extending from the first via to the second via. The first conductive path may also include a second leg extending from the third via to the fourth via. The second conductive path may include a first leg extending from the second via to the third via.

In further embodiments, the plurality of vias includes a first via, a second via, a third via, a fourth via, a fifth via, and a sixth via. For example, the first via, third via, and fifth via may be defined along the first side of the core or multilayer structure, and the second via, fourth via, and sixth via may be defined along the second side of the core or multilayer structure. The first conductive path may include a first leg extending from the first via to the second via, a second leg extending from the third via to the fourth via, and a third leg extending from the fifth via to the sixth via. The second conductive path may include a first leg extending from the second via to the third via. The second conductive path may also include a second leg extending from the fourth via to the fifth via.

In some embodiments, at least one via of the plurality of vias is lined or plated with a conductive material, which may include, e.g., copper, nickel, gold, silver, or other metals or alloys. In some embodiments, at least one via of the plurality of vias is filled with a conductive material. For instance, one or more vias may be filled with conductive material such that a solid column of conductive material is formed. Alternatively, or additionally, the interior surface of one or more of the through holes may be plated such that one or more vias are hollow but are lined with conductive material. The vias may be formed by drilling (e.g., mechanical drilling, laser drilling, etc.) through holes and plating or filling the through holes with a conductive material, for example, using electroless plating or seeded copper.

In some embodiments, the core comprises a ferrite material. The ferrite material can, for example, increase the inductance of the inductor. Similar materials also may be used to increase inductance without changing the structure of the inductor (e.g., using the same or similar core, via, and conductive path structure). In other embodiments, however, any suitable material, e.g., a dielectric material such as glass or the like, may be used to form the core.

In some embodiments, the core may be a monolithic block or body of material. For instance, the core may be a hexahedron, i.e., a six-sided block or body, such as a rectangular parallelopiped (or cuboid) shaped body. A six-sided core body may include six surfaces defining the body, such as a top surface, a bottom surface opposite the top surface, a first end surface extending between the top and bottom surfaces, a second end surface opposite the first end surface and extending between the top and bottom surfaces, a first side surface extending between the top and bottom surfaces as well as the first and second end surfaces, and a second side surface opposite the first side surface and extending between the top and bottom surfaces as well as the first and second end surfaces.

As described above, in some embodiments, the inductor may be formed in a multilayer structure. A multilayer may include a plurality of dielectric layers stacked along a Z-direction. For instance, a plurality of dielectric layers that are stacked with or without a core to form a multilayer structure. The plurality of dielectric layers in the multilayer structure described herein may include one or more dielectric materials. In some embodiments, the one or more dielectric materials may have a low dielectric constant. The dielectric constant may be less than about 120, in some embodiments less than about 100, in some embodiments less than about 75, in some embodiments less than about 50, in some embodiments less than about 25, in some embodiments less than about 15, and in some embodiments less than about 5. For instance, in some embodiments, the dielectric constant may range from about 1.5 to about 120, in some embodiments from about 1.5 to about 100, in some embodiments from about 1.5 to about 75, and in some embodiments from about 2 to about 8. For example, a dielectric material having a dielectric constant higher than 30 may be used to achieve higher frequencies and/or smaller components. In such embodiments, the dielectric constant may range from about 30 to about 120, or greater, in some embodiments from about 50 to about 100, and in some embodiments from about 70 to about 90.

In some embodiments, the one or more dielectric materials may include organic dielectric materials. Example organic dielectric include polyphenyl ether (PPE) based materials, such as LD621 from Polyclad and N6000 series from Park/Nelco Corporation, liquid crystalline polymer (LCP), such as LCP from Rogers Corporation or W. L. Gore & Associates, Inc., hydrocarbon composites, such as 4000 series from Rogers Corporation, and epoxy-based laminates, such as N4000 series from Park/Nelco Corp. For instance, examples include epoxy based N4000-13, bromine-free material laminated to LCP, organic layers with high K material, unfilled high-K organic layers, Rogers 4350, Rogers 4003 material, and other thermoplastic materials such as polyphenylene sulfide resins, polyethylene terephthalate resins, polybutylene terephthalate resins, polyethylene sulfide resins, polyether ketone resins, polytetraflouroethylene resins and graft resins, or similar low dielectric constant, low-loss organic material.

In some embodiments, the dielectric material may be a ceramic-filled epoxy. For example, the dielectric material may include an organic compound, such as a polymer (e.g., an epoxy) and may contain particles of a ceramic dielectric material, such as barium titanate, calcium titanate, zinc oxide, alumina with low-fire glass, or other suitable ceramic or glass-bonded materials. In some embodiments, the dielectric material may be an organic compound such as an epoxy (with or without ceramic mixed in, with or without fiberglass), popular as circuit board materials, or other plastics common as dielectrics. In these cases, the conductor is usually a copper foil which is chemically etched to provide the patterns. In still further embodiments, dielectric material may comprise a material having a relatively high dielectric constant (K), such as one of NPO (COG), X7R, X5R X7S, Z5U, Y5V and strontium titanate. In such examples, the dielectric material may have a dielectric constant that is greater than 100, for example within a range from between about 100 to about 4000, in some embodiments from about 1000 to about 3000.

Other materials may be utilized, however, including, N6000, epoxy based N4000-13, bromine-free material laminated to LCP, organic layers with high K material, unfilled high-K organic layers, Rogers 4350, Rogers 4003 material (from the Rogers Corporation), and other thermoplastic materials such as hydrocarbon, Teflon, FR4, epoxy, polyamide, polyimide, and acrylate, polyphenylene sulfide resins, polyethylene terephthalate resins, polybutylene terephthalate resins, polyethylene sulfide resins, polyether ketone resins, polytetraflouroethylene resins, BT resin composites (e.g., Speedboard C), thermosets (e.g., Hitachi MCL-LX-67F), and graft resins, or similar low dielectric constant, low-loss organic material.

Additionally, in some embodiments, non-organic dielectric materials may be used including a ceramic, semi-conductive, or insulating materials, such as, but not limited to, sapphire, ruby, alumina (Al₂O₃), aluminum nitride (AlN), beryllium oxide (BeO), aluminum oxide (Al₂O₃), boron nitride (BN), silicon (Si), silicon carbide (SiC), silica (SiO₂), silicon nitride (Si₃N₄), gallium arsenide (GaAs), gallium nitride (GaN), zirconium dioxide (ZrO2), mixtures thereof, oxides and/or nitrides of such materials, or any other suitable ceramic material. Additional example ceramic materials include barium titanate (BaTiO₃), calcium titanate (CaTiO₃), zinc oxide (ZnO), ceramics containing low-fire glass, or other glass-bonded materials. Dielectric materials such as diamond may be used as well.

The first and second conductive paths of the inductor may be formed over first and second surfaces of the core, as described above, or may be formed over first and second surfaces of the multilayer structure that are defined by a first dielectric layer and a second dielectric layer, respectively. For example, whether stacked with or without the core, in some embodiments a first dielectric layer defines the first surface of the inductor and a second dielectric layer defines the second surface of the inductor, with the first and second conductive paths formed over the first and second surfaces, respectively. In such embodiments, the first and second conductive paths may be referred to as patterned conductive layers formed over respective dielectric layers.

In some embodiments, when the first dielectric layer and the second dielectric layer define the first surface and the second surface, respectively, the first surface and the second surface may be outer surfaces of the multilayer structure. For example, the first surface may be a top surface of the multilayer structure and the second surface may be a bottom surface of the multilayer structure, with the Z-direction defining a vertical direction.

The conductive paths may be formed from a variety of conductive materials. For example, the first and second conductive paths may include copper, nickel, gold, silver, or other metals or alloys.

The conductive paths may be formed using a variety of suitable techniques. Subtractive, semi-additive or fully additive processes may be employed with panel or pattern electroplating of the conductive material followed by print and etch steps to define the patterned conductive layers. Photolithography, plating (e.g., electrolytic), sputtering, vacuum deposition, printing, or other techniques may be used to form the conductive paths. For example, a thin layer (e.g., a foil) of a conductive material may be adhered (e.g., laminated) to a surface of a core or a dielectric layer. The thin layer of conductive material may be selectively etched using a mask and photolithography to produce a desired pattern of the conductive material on the surface of the core or the dielectric material.

In some embodiments, the first conductive path and/or the second conductive path may be a thin-film patterned conductive layer formed over a core surface or a dielectric layer surface. In some embodiments, the thin-film conductive path(s) can be relatively thick for thin-film components, e.g., each thin-film conductive path may have a thickness that ranges from 20 micrometers to about 80 micrometers, in some embodiments from about 30 micrometers to about 70 micrometers, in some embodiments from about 40 micrometers to about 60 micrometers, and in some embodiments from about 45 micrometers to about 55 micrometers. Such thicknesses have been found to reduce heat generation by the thin-film inductors when large power currents are applied, but such thicknesses are not so large as to prevent strong adhesion between substrate and/or dielectric layers that are adjacent the thin-film inductors. In other embodiments, the one or more thin-film inductors may be thinner, i.e., have a thickness less than 20 micrometers.

The one or more thin-film conductive paths may be precisely formed using a variety of suitable subtractive, semi-additive, or fully additive processes. For example, physical vapor deposition and/or chemical deposition may be used. For instance, in some embodiments, thin-film components may be formed using sputtering, a type of physical vapor deposition. A variety of other suitable processes may be used, however, including evaporation, atomic layer deposition (ALD), plasma-enhanced chemical vapor deposition (PECVD), electroless plating, and electroplating, for example. Lithography masks and etching may be used to produce the desired shape or pattern of the thin-film components. A variety of suitable etching techniques may be used, including dry etching using a plasma of a reactive or non-reactive gas (e.g., argon, nitrogen, oxygen, chlorine, boron trichloride, carbon tetrafluoride, sulfur hexafluoride) and/or wet etching.

Similar to the core structure described above, the multilayer structure can include at least one via, which may be a hollow plated via or a filled via as described herein. The at least one via of the multilayer structure may extend from the first surface to the second surface and contact both the first conductive path and the second conductive path to electrically connect the first conductive path to the second conductive path. Thus, the first conductive path, the second conductive path, and the via may form the inductor of the multilayer structure. It will be appreciated that one or more inductors may be formed in the multilayer structure.

As described above, in some embodiments, a multilayer structure may include an inductor as well as one or more additional passive components. Such additional passive components may be formed from one or more conductive layers that are stacked with the core and/or the dielectric layers over which are formed the first conductive path and the second conductive path. For instance, conductive material may be deposited over two dielectric layers of the multilayer structure to form a capacitor, which may be electrically connected to the inductor or to another component. Additionally or alternatively, other components, such as one or more varistors, resistors, fuses, diodes, transformers, sensors, electrostatic discharge (ESD) devices, memory devices, radio frequency devices, power amplifiers, power management devices, antennas, microelectromechanical systems (MEMS) devices and/or the like may be formed within the multilayer structure, e.g., such as from one or more conductive layers stacked together to form the multilayer structure including the first and second conductive paths that form an inductor as described herein. Further, as described above, conductive material formed over one or more dielectric layers of the multilayer structure may be used to route signals, lengthen the inductor formed by the first conductive path and the second conductive path as described herein, etc.

Whether formed as a core structure or as part of a multilayer structure, an inductor as described herein may have a lower profile than other inductors known in the art. For example, an inductor as described herein may have a thickness in the Z-direction from the first surface to the second surface of about 100 mil or less, about 80 mil or less, about 50 mil or less, about 20 mil or less, or about 10 mil or less (about 2500 micrometers or less, about 2000 micrometers or less, about 1250 micrometers or less, about 500 micrometers or less, or about 250 micrometers or less). For instance, the thickness in the Z-direction may be within a range of about 10 mil to about 100 mil, about 10 mil to about 80 mil, or about 20 mil to about 50 mil (about 250 micrometers to about 2500 micrometers, about 250 micrometers to about 2000 micrometers, or about 500 micrometers to about 1250 micrometers).

Further, an inductor formed as described herein may have a higher inductance than typical inductors. For example, an inductor as described herein may have an inductance that is at least two times (2×) the inductance of an inductor formed by traditional methods (such as a known coil shape) having the same length and width as an inductor formed as described herein. In some embodiments, an inductor as described herein may have an inductance that is at least 2.5 times (2.5×), in some embodiments at least three times (3×), or in some embodiments at least four times (4×) the inductance of an inductor formed by traditional methods (such as a known coil shape) having the same length and width as an inductor formed as described herein.

An inductor or multilayer structure as described herein may be incorporated into an assembly. In some embodiments, the assembly may include an inductor or multilayer structure as described herein, as well as a device. The device may include a device substrate, and the inductor or multilayer structure may be attached to the device substrate. The device substrate may be, e.g., a printed circuit board (PCB) or the like formed from any suitable material.

In some embodiments, the device substrate may define a mounting surface, which may extend in a mounting plane parallel to an X-Y plane. The first surface and the second surface, on which are defined the first conductive path and the second conductive path, respectively, may each extend parallel to the mounting plane. In some embodiments, one of the first surface or the second surface may include an input pad and an output pad, as described herein, which may be connected to terminals of the device, e.g., as defined on the mounting surface of the device substrate.

The present subject matter also may include methods for forming inductors and multilayer structures as described herein. In some embodiments, a method for forming an inductor includes forming a core having a first surface and a second surface opposite the first surface along a Z-direction. The core may be formed, e.g., from a ferrite or other material, such as a monolithic block or body of material. The method may also include defining a plurality of vias in the core, each via of the plurality of vias extending from the first surface to the second surface. The vias may be formed by drilling, cutting, or otherwise defining the vias through the core material. The method may further include forming a first conductive path on the first surface of the core and forming a second conductive path on the second surface of the core. Forming the conductive paths may include using photolithography, plating, sputtering, vacuum deposition, printing, or other techniques, including other thin-film techniques, to deposit one or more conductive materials on the first surface and the second surface of the core. In some embodiments, the first conductive path extends between a first portion of the plurality of vias, the second conductive path extends between a second portion of the plurality of vias, and at least one via of the plurality of vias is included in both the first portion of the plurality of vias and the second portion of the plurality of vias.

In other embodiments, a method for forming a multilayer structure includes forming a plurality of dielectric layers, such as from one or more dielectric materials as described herein. The method also includes stacking the plurality of dielectric layers along a Z-direction. In some embodiments, the method further includes forming a core and stacking the core with the plurality of dielectric layers, e.g., such that the core is sandwiched by the dielectric layers or is otherwise stacked with the plurality of dielectric layers. The method may also include defining at least one via extending from a first surface to a second surface, the second surface opposite the first surface along the Z-direction. In some embodiments, the first surface and the second surface are defined by a core, but in other embodiments, at least one of the first surface or the second surface is defined by a dielectric layer of the plurality of dielectric layers. As such, the at least one via may extend through the core and/or through one or more dielectric layers to extend from the first surface to the second surface.

The method for forming the multilayer structure may also include forming a first conductive path on the first surface and forming a second conductive path on the second surface, regardless of whether the first surface, the second surface, or both are defined by a core or dielectric layers. The via may contact both the first conductive path and the second conductive path to electrically connect the first conductive path to the second conductive path and to form an inductor as described herein.

As described, in some embodiments, a first dielectric layer of the plurality of dielectric layers defines the first surface such that the first conductive path is formed over the first surface of the first dielectric layer. A second dielectric layer of the plurality of dielectric layers may define the second surface such that the second conductive path is formed over the second surface of the second dielectric layer. In some embodiments, stacking the plurality of dielectric layers comprises stacking the first dielectric layer and the second dielectric layer with a remainder of the plurality of dielectric layers such that the first surface and the second surface are two outer surfaces of the multilayer structure. Alternatively, the multilayer structure may include a core, which can define one or both of the first and second surfaces. As described herein, the core may be sandwiched by dielectric layers or may define an outer surface of the multilayer structure.

As used herein, “formed over” may refer to a layer that is directly in contact with another layer. However, one or more intermediate layers and/or coatings may also be formed therebetween. Additionally, when used in reference to a bottom surface, “formed over” may be used relative to an exterior surface of the component. Thus, a layer that is “formed over” a bottom surface may be closer to the exterior of the component than the layer over which it is formed.

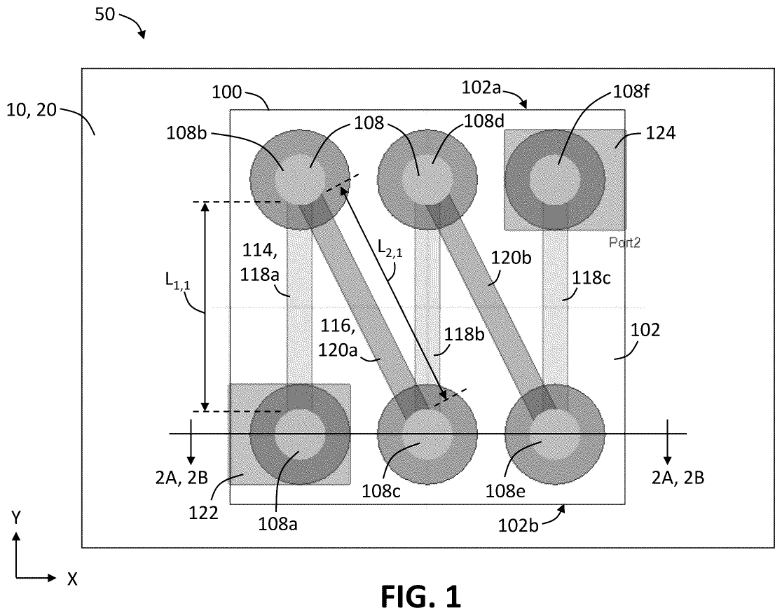

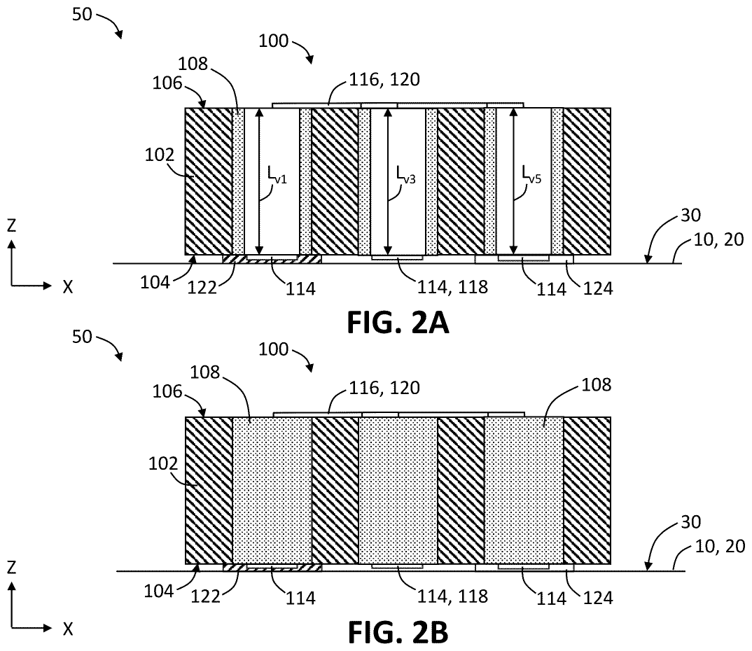

Referring now to the figures, various embodiments of the present invention will now be described in more detail. FIG. 1 provides a schematic top view of an assembly 50 including an inductor 100 disposed on a device 10. FIGS. 2A and 2B provide schematic cross-section views of the assembly 50 taken along the line 2A, 2B of FIG. 1; the embodiments of FIGS. 2A and 2B differ as to whether the illustrated vias 108 are plated, hollow vias or filled vias but the figures are otherwise the same.

As shown in FIGS. 2A and 2B, the inductor 100 is disposed on a device substrate 20 of the device 10. More particularly, the inductor 100 as shown in each of FIG. 2A and FIG. 2B is disposed on a mounting surface 30 of the device substrate 20. The device substrate 20 may be, e.g., a printed circuit board (PCB) or the like formed from any suitable material.

As shown in FIGS. 1, 2A, and 2B, the inductor 100 includes a core 102 having a first surface 104 and a second surface 106. In FIG. 1, the core 102 is illustrated as transparent to simultaneously illustrate a first conductive path 114 defined on the first surface 104 and a second conductive path 116 defined on the second surface 106. The second surface 106 is opposite the first surface 104 along a Z-direction (FIGS. 2A, 2B), which is perpendicular to both an X-direction and a Y-direction. The X-direction and the Y-direction are perpendicular to one another. The core 102 may include a ferrite material, or the core 102 may be formed from any suitable material as described elsewhere herein.

As further illustrated in FIG. 1, a plurality of vias 108 are defined in the core 102. Referring to FIGS. 2A and 2B, the vias 108 extend from the first surface 104 to the second surface 106. In the embodiment of FIG. 2A, the vias 108 are through holes having the interior surfaces thereof plated with conductive material such that the vias 108 are hollow. In the embodiment of FIG. 2B, the vias 108 are through holes filled with conductive material such that each via 108 forms a solid column of conductive material. In various embodiments, each of the vias 108 may be filled, each of the vias 108 may be plated hollow vias, or a mix of filled and plated hollow vias 108 may be used. Exemplary conductive materials and methods for forming the via through holes are described in greater detail above. In the embodiment of FIG. 1, six vias 108 are defined in the core 102, but it will be appreciated that any suitable number of vias 108 may be defined in the core 102.

A first conductive path 114 is defined on the first surface 104, and a second conductive path 116 is defined on the second surface 106. In various embodiments of the inductor 100, at least one via 108 of the plurality of vias 108 contacts both the first conductive path 114 and the second conductive path 116 to electrically connect the first conductive path 114 to the second conductive path 116. In the embodiment illustrated in FIG. 1, four vias 108 of the six vias 108 defined in the core 102 contact both the first conductive path 114 and the second conductive path 116.

In some embodiments, the first conductive path 114 extends between at least a first portion of the plurality of vias 108, and the second conductive path 116 extends between at least a second portion of the plurality of vias 108. In such embodiments, at least one via 108 of the plurality of vias 108 is included in both the first portion of the plurality of vias 108 and the second portion of the plurality of vias 108. For instance, as shown in FIG. 1, the first conductive path 114 extends between all six vias 108 defined in the core 102, and the second conductive path 116 extends between four vias 108 of the six vias 108 defined in the core 102.

As further illustrated in FIG. 1, in some embodiments, the plurality of vias are defined along a first side 102a and a second side 102b of the core 102. For example, the first side 102a may be opposite the second side 102b along a Y-direction that is perpendicular to the Z-direction and an X-direction. In the embodiment of FIG. 1, the vias 108 defined along the first side 102a are spaced apart from one another along the X-direction, and the vias 108 defined along the second side 102b are spaced apart from one another along the X-direction.

Further, at least one via 108 of the first portion of the plurality of vias 108 may be defined adjacent the first side 102a, and at least one via 108 of the first portion of the plurality of vias 108 may be defined adjacent the second side 102b. Moreover, at least one via 108 of the second portion of the plurality of vias 108 may be defined adjacent the first side 102a, and at least one via 108 of the second portion of the plurality of vias 108 may be defined adjacent the second side 102b. In the embodiment of FIG. 1, three vias 108 of the six vias 108 are defined adjacent the first side 102a, and three vias 108 of the six vias 108 are defined adjacent the second side 102b. As such, three vias 108 of the six vias 108 connected to the first conductive path 114 are defined adjacent the first side 102a, and three vias 108 of the six vias 108 connected to the first conductive path 114 are defined adjacent the second side 102b. Additionally, two vias 108 of the four vias 108 connected to the second conductive path 116 are defined adjacent the first side 102a, and two vias 108 of the four vias 108 connected to the second conductive path 116 are defined adjacent the second side 102b.

Each conductive path 114, 116 may include a plurality of legs 118, 120 and each leg 118, 120 of the plurality of legs 118, 120 may extend between a respective two vias 108 of the plurality of vias 108. For example, as shown in FIG. 1, the plurality of vias 108 includes a first via 108a, a second via 108b, a third via 108c, a fourth via 108d, a fifth via 108e, and a sixth via 108f. The first conductive path 114 comprises a first leg 118a extending from the first via 108a to the second via 108b, a second leg 118b extending from the third via 108c to the fourth via 108d, and a third leg 118c extending from the fifth via 108e to the sixth via 108f. Further, in the embodiment of FIG. 1, the second conductive path 116 comprises a first leg 120a extending from the second via 108b to the third via 108c and a second leg 120b extending from the fourth via 108d to the fifth via 108e.

Other numbers of vias 108 and portions or legs 118, 120 of the first and second conductive paths 114, 116 may be used as well. For instance, in some embodiments, the plurality of vias 108 includes a first via 108a, a second via 108b, and a third via 108c, and the first conductive path 114 extends from the first via 108a to the second via 108b, and the second conductive path 116 extends from the second via 108b to the third via 108c. In other embodiments, the plurality of vias 108 includes a first via 108a, a second via 108b, a third via 108c, and a fourth via 108d, and the first conductive path 114 comprises a first leg 118a extending from the first via 108a to the second via 108b and a second leg 118b extending from the third via 108c to the fourth via 108d, and the second conductive path 116 comprises a first leg 120a extending from the second via 108b to the third via 108c. It will be appreciated that the inductor 100 also may include fewer than three vias 108 or more than six vias 108.

Referring still to FIGS. 1, 2A, and 2B, at least one via 108 of the plurality of vias 108 is electrically connected to an input 122 and to an output 124. For example, as shown in FIG. 1, one via 108 (the first via 108a) is electrically connected to the input 122, and another via 108 (the sixth via 108f) is electrically connected to the output 124, with both the input 122 and the output 124 defined on the first surface 104 of the core 102. Further, in the depicted embodiment, the input 122 comprises an input pad and the output 124 comprises an output pad. For instance, both the input pad 122 and the output pad 124 are formed from a conductive material in a generally rectangular shape that has a perimeter that surrounds the end of the respective via 108 defined at the first surface 104 of the core 102. However, it will be understood that the input pad 122 and the output pad 124 may have any suitable shape or size, e.g., one or both of the input pad 122 or the output pad 124 may be configured as a relatively thin strip that contacts the respective via 108. Moreover, it will be appreciated that both the input pad 122 and the output pad 124 are defined on the same surface, e.g., either the first surface 104 or the second surface 106 of the core 102, such as to facilitate surface mounting of the inductor 100 to a device such as the device 10. For example, in the figures, the first surface 104 is a bottom surface or mounting surface of the inductor 100, which is positioned facing the mounting surface 30 of the device substrate 20 when the inductor 100 is mounted on the device substrate 20. Accordingly, in the depicted embodiments, the second surface 106 is a top surface of the inductor 100, and the Z-direction is a vertical direction.

The input 122 and the output 124 can define a first end and a second end of the inductor 100, and the inductor 100 has an inductor length from the first end to the second end. The inductor length includes a length in the Z-direction of each via 108 of the plurality of vias 108 that contacts at least one of the first conductive path 114 or the second conductive path 116, a length of each leg 118 of the plurality of legs 118 of the first conductive path 114, and a length of each leg 120 of the plurality of legs 120 of the second conductive path 116.

For example, as illustrated in FIG. 1, the first conductive path 114 extends along the first surface 104 of the core 102 from the first via 108a to the sixth via 108f, with three legs 118 that each extend between a respective two vias 108 such that the first conductive path 114 contacts each of the six vias 108 of the depicted inductor 100. The second conductive path 116 extends along the second surface 106 of the core 102 from the second via 108b to the fifth via 108e, with two legs 120 that each extend between a respective two vias 108 such that the second conductive path 116 contacts four of the six vias 108 of the depicted inductor 100. The inductor length of the inductor 100 is the sum of the length of each leg 118 of the first conductive path 114, the length of each leg 120 of the second conductive path 116, and the length along the Z-direction of each of the six vias 108. As such, the inductor length is the sum of the lengths of conductive material that connect the input 122 to the output 124.

It will be appreciated that the length of each leg 118 of the first conductive path 114 may be measured along the first surface 104 from one via 108 to the other via 108 between which extends the respective leg 118. Likewise, the length of each leg 120 of the second conductive path 116 may be measured along the second surface 106 from one via 108 to the other via 108 between which extends the respective leg 120. As one example, referring to FIG. 1, the first leg 118a of the first conductive path 114 has a length L_{1,1} from the first via 108a to the second via 108b, and the first leg 120a of the second conductive path 116 has a length L_{2,1} from the second via 108b to the third via 108c. Similarly, the second leg 118b of the first conductive path 114 has a length L_{1,2} from the third via 108c to the fourth via 108d, the third leg 118c of the first conductive path 114 has a length L_{1,3} from the fifth via 108e to the sixth via 108f, and the second leg 120b of the second conductive path 116 has a length L_{2,2} from the fourth via 108d to the fifth via 108e. As shown in FIG. 2A, the first via 108a has a length Lᵥ₁ in the Z-direction from the first surface 104 and the second surface 106, and the third via 108c and fifth via 108e have lengths Lᵥ₃, Lᵥ₅, respectively, in the Z-direction from the first surface 104 and the second surface 106. It will be understood that, for the embodiments of the inductor 100 illustrated in FIGS. 1, 2A, and 2B, the second via 108b, fourth via 108d, and sixth via 108f have similar lengths in the Z-direction from the first surface 104 and the second surface 106 as the lengths Lᵥ₁, Lᵥ₃, Lᵥ₅, of the first via 108a, third via 108c, and fifth via 108e illustrated in FIG. 2A.

In some embodiments, the plurality of vias 108 are defined along two or more edges of the core 102 to maximize the inductor length of the inductor 100. That is, the vias 108 can be defined as close to the first side 102a and the second side 102b of the core 102 to maximize the length of each leg 118, 120 of the first and second conductive paths 114, 116. Maximizing the inductor length can help maximize the inductance of the inductor 100. Other factors, such as the core material, can also help increase or maximize the inductance of the inductor 100.

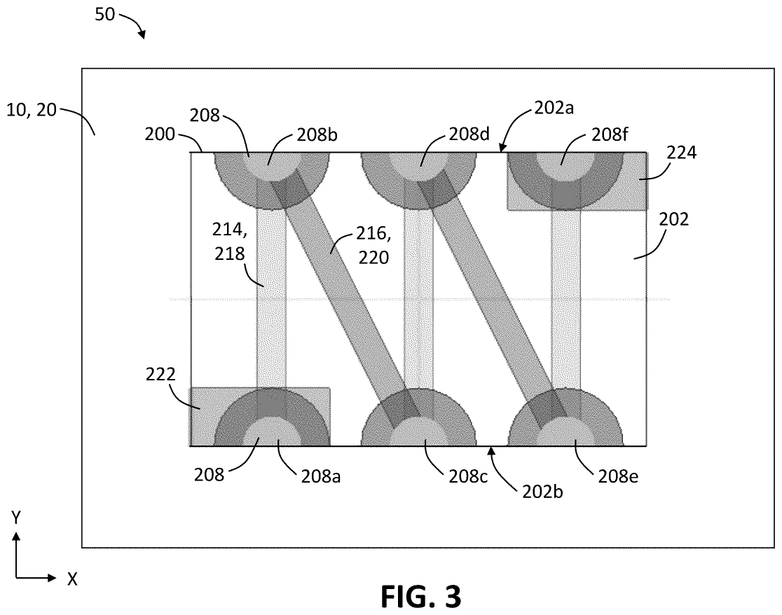

Referring now to FIG. 3, where similar reference numbers refer to the same or similar features, in some embodiments, one or more of the plurality of vias 208 are exposed along the first side 202a and/or the second side 202b of the core 202. As described elsewhere herein, an embodiment in which a plurality of vias 208 are exposed along at least one of the first side 202a or the second side 202b may be referred to as a castellated inductor. In some embodiments, a castellated inductor, such as the inductor 200 illustrated in FIG. 3, may be formed similarly to the inductor 100 of FIGS. 1, 2A, and 2B, but may be cut or diced through the vias 108 to define the first side 102a and the second side 202b of the core 202. The castellated inductor 200 can help maximize the inductor length, e.g., by lengthening the legs 218, 220 of the first and second conductive paths 214, 216 to thereby lengthen the conductive path from the input 222 to the output 224. It will be appreciated that, like FIG. 1, the core 202 of the inductor 200 in FIG. 3 is illustrated as transparent to simultaneously illustrate the first conductive path 214, input 222, and output 224 defined on the first surface 204 and the second conductive path 216 defined on the second surface 206.

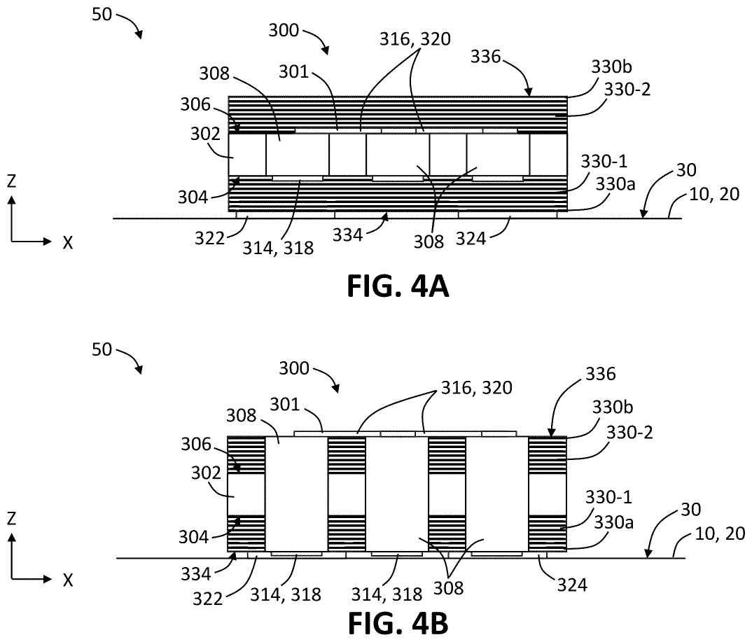

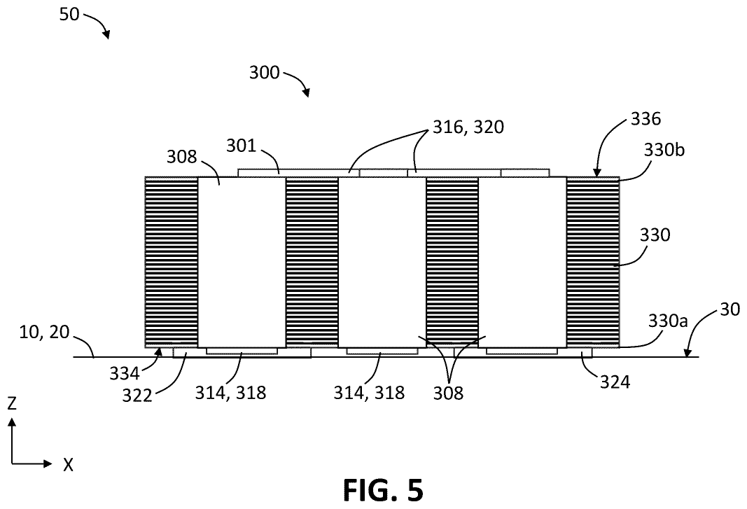

Turning now to FIGS. 4A, 4B, and 5, schematic cross-section views are provided of various embodiments of a multilayer structure 300 defining an inductor. It will be appreciate that similar reference numbers as used, e.g., with respect to FIGS. 1, 2A, 2B, and 3 denote the same or similar features. Generally, FIGS. 4A, 4B, and 5 each depict a multilayer structure 300 including a plurality of dielectric layers 330 stacked along a Z-direction. The multilayer structure 300 has a first surface 334 and a second surface 336 opposite the first surface 334 along the Z-direction. FIG. 4A illustrates the multilayer structure 300 having a core 302 sandwiched between the plurality of dielectric layers 330, with a first conductive path 314 and a second conductive path 316 defined on first and second surfaces 304, 306, respectively, of the core 302. FIG. 4B illustrates the multilayer structure 300 having a core 302 sandwiched between the plurality of dielectric layers 330, with a first conductive path 314 and a second conductive path 316 defined on the first and second surfaces 334, 336, respectively, of the multilayer structure 300. FIG. 5 illustrates the multilayer structure 300 without or omitting a core 302, and a first conductive path 314 and a second conductive path 316 are defined on the first and second surfaces 334, 336, respectively, of the multilayer structure 300.

Referring particularly to FIG. 4A, the multilayer structure 300 includes at least one via 308 extending from the first surface 304 to the second surface 306 of the core 302. As stated, in the embodiment of FIG. 4A, the first conductive path 314 is defined on the first surface 304 of the core 302, and the second conductive path 316 is defined on the second surface 306 of the core 302. The at least one via 308 contacts both the first conductive path 314 and the second conductive path 316 to electrically connect the first conductive path 314 to the second conductive path 316 such that the first conductive path 314, the second conductive path 316, and the via 308 form an inductor 301.

In the embodiments of FIGS. 4B and 5, a first dielectric layer 330a of the plurality of dielectric layers 330 defines the first surface 334 of the multilayer structure 300, and a second dielectric layer 330b of the plurality of dielectric layers 330 defines the second surface 336 of the multilayer structure 300. Further, in the depicted embodiments, the first surface 334 and the second surface 336 are two outer surfaces of the multilayer structure 300. As stated above, in the embodiments of FIGS. 4B and 5, the first conductive path 314 is defined on the first surface 334 of the multilayer structure 300, and the second conductive path 316 is defined on the second surface 336 of the multilayer structure 300. At least one via 308 extends from the first surface 334 to the second surface 336 and contacts both the first conductive path 314 and the second conductive path 316 to electrically connect the first conductive path 314 to the second conductive path 316 such that the first conductive path 314, the second conductive path 316, and the via 308 form an inductor 301. The difference between the embodiments of FIGS. 4B and 5 is the presence of the core 302; in FIG. 4B, the multilayer structure 300 includes a core 302 sandwiched in the plurality of dielectric layers 330, while the multilayer structure 300 of FIG. 5 comprises only dielectric layers 330 (some of which may include a conductive material disposed on at least one surface thereof) and does not include a core 302.

As shown in FIGS. 4A, 4B, and 5, the multilayer structure 300 may include a plurality of vias 308. For instance, each of the depicted multilayer structures 300 may include three, four, five, six, or more vias 308 as described above with respect to FIGS. 1, 2A, and 2B, or a multilayer structure 300 as described herein may include less than three vias 308. As also described above with respect to FIGS. 1, 2A, and 2B, each of the vias 308 of a respective multilayer structure 300 may be filled vias, may be plated hollow vias, or may be a mix of filled and plated hollow vias, and exemplary conductive materials and methods for forming the via through holes are described in greater detail elsewhere herein. Further, similar to the core 302 of the inductor 100 shown in FIG. 1, the vias 308 can be defined along a first side and a second side of the multilayer structure 300, e.g., where the first side is opposite the second side along a Y-direction that is perpendicular to the Z-direction and the vias 308 along each side are spaced apart from one another along an X-direction that is perpendicular to each of the Y-direction and the Z-direction. Moreover, in some embodiments, the plurality of vias 308 can be exposed along the first side and/or the second side of the multilayer structure 300, such as to form a castellated structure similar to the castellated inductor 200 described and shown in FIG. 3.

Further, the inductor 301 of the multilayer structure 300 may be similar to the inductor 100 described above, in that the inductor 301 extends from a first end at an input 322 (e.g., an input pad 322) to a second end at an output 324 (e.g., an output pad 324), with an inductor length from the first end to the second end that is defined by one or more vias 308, a first conductive path 314 having one or more legs 318, and a second conductive path 316 having one or more legs 320. Each leg 318, 320 may extend between a respective two vias 308, or at least between one of the input 322 or the output 324 and a via 308. The first conductive path 314 and the second conductive path 316 of the inductor 301 are formed on different surfaces and are electrically connected by one or more vias 308. The input 322 and the output 324 may be defined on the same surface, e.g., to facilitate surface mounting of the multilayer structure 300 such as on the mounting surface 30 of the device substrate 20 of the device 10.

As shown in FIGS. 4A and 4B, in embodiments of the multilayer structure 300 including a core 302, the core 302 may be stacked with the plurality of dielectric layers 330 along the Z-direction. For example, in FIGS. 4A and 4B, the core 302 is sandwiched by the plurality of dielectric layers 330 such that a portion 330-1 of the plurality of dielectric layers 330 are stacked against the first surface 304 of the core 302 and a remaining portion 330-2 of the plurality of dielectric layers 330 are stacked against the second surface 306 of the core 302. In other embodiments, the core 302 may be stacked with the dielectric layers 330 such that the core 302 defines one of a top surface or bottom surface of the multilayer structure 300 and a dielectric layer 330 of the plurality of dielectric layers 330 defines the other of the top surface or bottom surface of the multilayer structure 300. It will be appreciated that the core 302 may be formed from a ferrite material or other suitable material as described elsewhere herein.

Moreover, as described in greater detail above, in some embodiments, the multilayer structure 300 includes features or components in addition to the inductor 301. For instance, additional conductive material may be formed over one or more of the dielectric layers 330 to lengthen the inductor 301 (e.g., by electrically connecting the additional conductive material to the inductor 301), to define additional passive components, to route signals, etc.

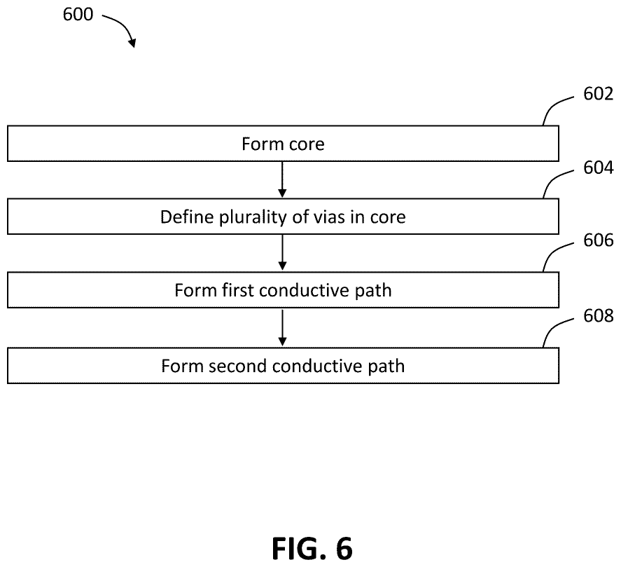

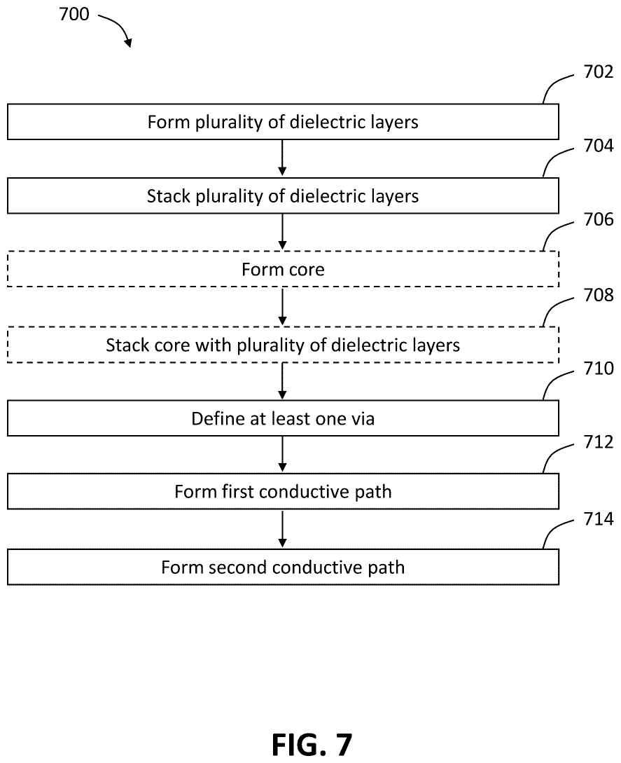

Turning now to FIGS. 6 and 7, the present subject matter also includes methods for forming inductors, multilayer structures, and assemblies as described herein. In various embodiments, the features or steps of each method may be performed in any suitable order using any appropriate technique.

Referring particularly to FIG. 6, a method 600 for forming an inductor 100, 200 includes (602) forming a core 302 having a first surface 104, 204 and a second surface 106, 206 opposite the first surface 104, 204 along a Z-direction. The method 600 also includes (604) defining a plurality of vias 108, 208 in the core 102, 202, each via 108, 208 of the plurality of vias 108, 208 extending from the first surface 104, 204 to the second surface 106, 206. Further, the method 600 includes (606) forming a first conductive path 114, 214 on the first surface 104, 204, the first conductive path 114, 214 extending between a first portion of the plurality of vias 108, 208, and (608) forming a second conductive path 116, 216 on the second surface 106, 206, the second conductive path 116, 216 extending between a second portion of the plurality of vias 108, 208. As described herein, at least one via 108, 208 of the plurality of vias 108, 208 is included in both the first portion of the plurality of vias 108, 208 and the second portion of the plurality of vias 108, 208 to electrically connect the first conductive path 114, 214 and the second conductive path 116, 216. Other features or steps of the method 600, e.g., consistent with the above description of the inductors 100, 200, may be included as well.

Referring to FIG. 7, a method 700 for forming a multilayer structure 300 includes (702) forming a plurality of dielectric layers 330 and (704) stacking the plurality of dielectric layers 330 along a Z-direction. In some embodiments, the method 700 also includes (706) forming a core 302 and (708) stacking the core 302 with the plurality of dielectric layers 330 along the Z-direction. The method 700 further includes (710) defining at least one via 308 extending from a first surface to a second surface, such as from a first surface 304 to a second surface 306 of the core 302 or from a first surface 334 to a second surface 336 of the multilayer structure 300. The method 700 additionally includes (712) forming a first conductive path 314 on a surface and (714) forming a second conductive path on a surface opposite the surface on which is formed the first conductive path 314. For example, as described herein, the first conductive path 314 may be defined on the first surface 304 of the core 302 and the second conductive path 316 defined on the second surface 306 of the core 302. Alternatively, the first conductive path 314 may be formed on the first surface 334 of the multilayer structure 300, which may be defined by the core 302 or a dielectric layer 330, and the second conductive path 316 may be formed on the second surface 336 of the multilayer structure 300, which may be defined by the core 302 or a dielectric layer 330. As described herein, the via 308 may be defined in the multilayer structure 300 such that the via 308 contacts both the first conductive path 314 and the second conductive path 316 to electrically connect the first conductive path 314 to the second conductive path 316 to form an inductor 301.

In methods for forming an assembly 50 including an inductor 100, 200 or a multilayer structure 300 as described herein, the method may include attaching the inductor 100, 200 or the multilayer structure 300 to a mounting surface 30 defined by a device substrate 20 of a device 10. For example, the inductor 100, 200 or the multilayer structure 300 may be mounted on the mounting surface 30 with the first surface 104, 204, 334 facing and/or contacting the mounting surface 30. The input 122, 222, 322 and output 124, 224, 324 of the inductor 100, 200, or multilayer structure 300 may be connected to an appropriate terminal of the device 10.

### Examples

Computer modeling was used to simulate inductors according to aspects of the present disclosure. The following table presents simulation data for various inductors constructed as described herein compared to simulation data for inductors constructed using traditional coil structures. Each simulated inductor (including the simulated inductors constructed according to an inventive design and the simulated inductors constructed according to a known or traditional design) had a length in the X-direction of 1 mm and a width in the Y-direction of 1 mm.

TABLE

| Inductance of Inductors of the | |
|---|---|
| Present Invention vs. | |
| Traditional Coil Inductors | |
| Inductor Type | Simulated Inductance |
| Inventive - Ferrite | 241.6 nH |
| Traditional - Ferrite | 85.3 nH |
| Inventive - Non-Ferrite | 19.7 nH |
| Traditional - Non-Ferrite | 9.3 nH |

As shown in the above Table, the simulated inventive inductor having a ferrite core had a simulated inductance of 241.6 nH, which was almost three times (3×) the simulated inductance of 85.3 nH of a same sized inductor having a ferrite core but constructed using a traditional coil shape. The simulated inventive inductor having a multilayer structure had a simulated inductance of 19.7 nH, which was more than two times (2×) the simulated inductance of 9.3 nH of a same sized inductor constructed using a traditional coil shape.

These and other modifications and variations of the present invention may be practiced by those of ordinary skill in the art, without departing from the spirit and scope of the present invention. In addition, it should be understood that aspects of the various embodiments may be interchanged both in whole or in part. Further, those of ordinary skill in the art will appreciate that the foregoing description is by way of example only and is not intended to limit the invention so further described in such appended claims.

What is claimed is:

1. A multilayer structure, comprising:
a plurality of dielectric layers stacked along a Z-direction;
a first surface;
a second surface opposite the first surface along the Z-direction;
a via extending from the first surface to the second surface;
a first conductive path defined on the first surface; and
a second conductive path defined on the second surface,
wherein the via contacts both the first conductive path and the second conductive path to electrically connect the first conductive path to the second conductive path, and
wherein the first conductive path, the second conductive path, and the via form an inductor.

2. The multilayer structure of claim 1, wherein a first dielectric layer of the plurality of dielectric layers defines the first surface.

3. The multilayer structure of claim 2, wherein a second dielectric layer of the plurality of dielectric layers defines the second surface.

4. The multilayer structure of claim 3, wherein the first surface and the second surface are two outer surfaces of the multilayer structure.

5. The multilayer structure of claim 1, further comprising a core stacked with the plurality of dielectric layers along the Z-direction.

6. The multilayer structure of claim 5, wherein the core defines the first surface and the second surface.

7. The multilayer structure of claim 6, wherein the core is sandwiched by the plurality of dielectric layers such that a portion of the plurality of dielectric layers are stacked against the first surface and a remaining portion of the plurality of dielectric layers are stacked against the second surface.

8. The multilayer structure of claim 5, wherein a first dielectric layer of the plurality of dielectric layers defines the first surface.

9. The multilayer structure of claim 8, wherein a second dielectric layer of the plurality of dielectric layers defines the second surface, and wherein the first surface and the second surface are two outer surfaces of the multilayer structure.

10. The multilayer structure of claim 5, wherein the core comprises a ferrite material.

11. The multilayer structure of claim 1, wherein the via is one via of a plurality of vias, wherein the first conductive path comprises a plurality of legs, each leg of the plurality of legs extending on the first surface between a respective two vias of the plurality of vias, and wherein the second conductive path comprises a plurality of legs, each leg of the plurality of legs extending on the second surface between a respective two vias of the plurality of vias.

12. The multilayer structure of claim 1, wherein the inductor has an inductor length from a first end at an input to a second end at an output.

13. The multilayer structure of claim 12, wherein:
the via is one via of a plurality of vias;
the first conductive path includes a plurality of legs, each leg of the plurality of legs of the first conductive path extending on the first surface between a respective two vias of the plurality of vias;
the second conductive path includes a plurality of legs, each leg of the plurality of legs of the second conductive path extending on the second surface between a respective two vias of the plurality of vias;
the inductor length includes a length in the Z-direction of each via of the plurality of vias that contacts at least one of the first conductive path or the second conductive path, a length of each leg of the plurality of legs of the first conductive path, and a length of each leg of the plurality of legs of the second conductive path.

14. The multilayer structure of claim 1, wherein:
the via is one via of a plurality of vias extending from the first surface to the second surface;
the first conductive path extends between a first portion of the plurality of vias; and
the second conductive path extends between a second portion of the plurality of vias,
at least one via of the plurality of vias is included in both the first portion of the plurality of vias and the second portion of the plurality of vias, and
the first conductive path, the second conductive path, the first portion of the plurality of vias, and second portion of the plurality of vias form the inductor.

15. The multilayer structure of claim 14, wherein the plurality of vias are defined along a first side and a second side of the multilayer structure, the first side opposite the second side along a Y-direction that is perpendicular to the Z-direction, and wherein the plurality of vias defined along the first side are spaced apart from one another along an X-direction and the plurality of vias defined along the second side are spaced apart from one another along the X-direction, the X-direction perpendicular to each of the Y-direction and the Z-direction.

16. The multilayer structure of claim 15, wherein at least one via of the first portion of the plurality of vias is defined adjacent the first side and at least one via of the first portion of the plurality of vias is defined adjacent the second side, and wherein at least one via of the second portion of the plurality of vias is defined adjacent the first side and at least one via of the second portion of the plurality of vias is defined adjacent the second side.

17. The multilayer structure of claim 15, wherein the plurality of vias are exposed along the first side and the second side of the multilayer structure.

18. The multilayer structure of claim 14, wherein one via of the plurality of vias is electrically connected to an input and another via of the plurality of vias is electrically connected to an output.

19. The multilayer structure of claim 18, wherein the input comprises an input pad and the output comprises an output pad, wherein both the input pad and the output pad are formed from a conductive material, and wherein both the input pad and the output pad are defined on either the first surface or the second surface.

20. A method of forming a multilayer structure, the method comprising:
forming a plurality of dielectric layers;
stacking the plurality of dielectric layers along a Z-direction;
defining at least one via extending from a first surface to a second surface, the second surface opposite the first surface along the Z-direction;
forming a first conductive path on the first surface; and
forming a second conductive path on the second surface,
wherein the via contacts both the first conductive path and the second conductive path to electrically connect the first conductive path to the second conductive path, and
wherein the first conductive path, the second conductive path, and the via form an inductor.
